(19) United States
(12) Patent Application Publication
(10) Pub. No.: US 2025/0050754 A1
(43) Pub. Date: Feb. 13, 2025

(54) VEHICLE CHARGING PORT WITH ADAPTER TO ENABLE CHARGING VIA DIFFERENT CHARGERS

(71) Applicant: Ford Global Technologies, LLC, Dearborn, MI (US)

(72) Inventors: Kevin Mackenzie, Canton, MI (US); Kevin Higgins, Waterford, MI (US)

(21) Appl. No.: 18/447,607

(22) Filed: Aug. 10, 2023

(51) Int. Cl. B60L 53/16; B60L 53/22; H02J 7/02

(52) U.S. Cl. CPC B60L 53/16; B60L 53/22; H02J 7/02; B60L 2210/30; H02J 2207/20

(57) ABSTRACT

A vehicle single charging port with an adapter to enable charging of an electric vehicle by way of different alternating current (AC) chargers is disclosed. The adapter may be configured to transfer electric power between a single Society of Automotive Engineers (SAE) J3068 receiving port and a SAE J1772 coupler according to an included method.

### FIELD

The present description relates generally to a charging port for a vehicle that supports more than one charge coupler. The charging port may accept charge from alternating current (AC) chargers and direct current (DC) chargers.

### BACKGROUND/SUMMARY

An electric vehicle may receive charge via AC chargers or DC chargers. AC charge is available via single phase power at a first voltage (e.g., 110 volts) or a second voltage (e.g., 220 volts). Further, AC charge may be available as three phase power. The different forms of AC charging may permit different rates of charge to be delivered to a vehicle. The different forms of AC charging may be delivered via different couplers, and the couplers that carry the DC charge are different than the couplers that carry the AC charge. In order to receive the different forms of AC charge, a plurality of different vehicle charging ports may be provided. However, multiple different types of charging ports may occupy excess surface area of a vehicle's exterior and may complicate vehicle wiring. Therefore, it may be desirable to provide a way for a vehicle to accept a DC charging coupler and different forms of AC charging couplers in a way that reduces the amount of vehicle surface area to mount the different vehicle charging ports.

It may be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 is a schematic diagram of an example vehicle driveline;

FIGS. 2 and 3 show front views of two different couplers for charging a vehicle;

FIGS. 4 and 5 show how two different couplers may be installed in a single vehicle charging port;

FIG. 6 shows a block diagram that illustrates electrical connections between a vehicle charging port, a charge adapter, and a charge coupler; and

FIGS. 7-9 show flowcharts of sequences for charging a vehicle via a single charging port.

### DETAILED DESCRIPTION

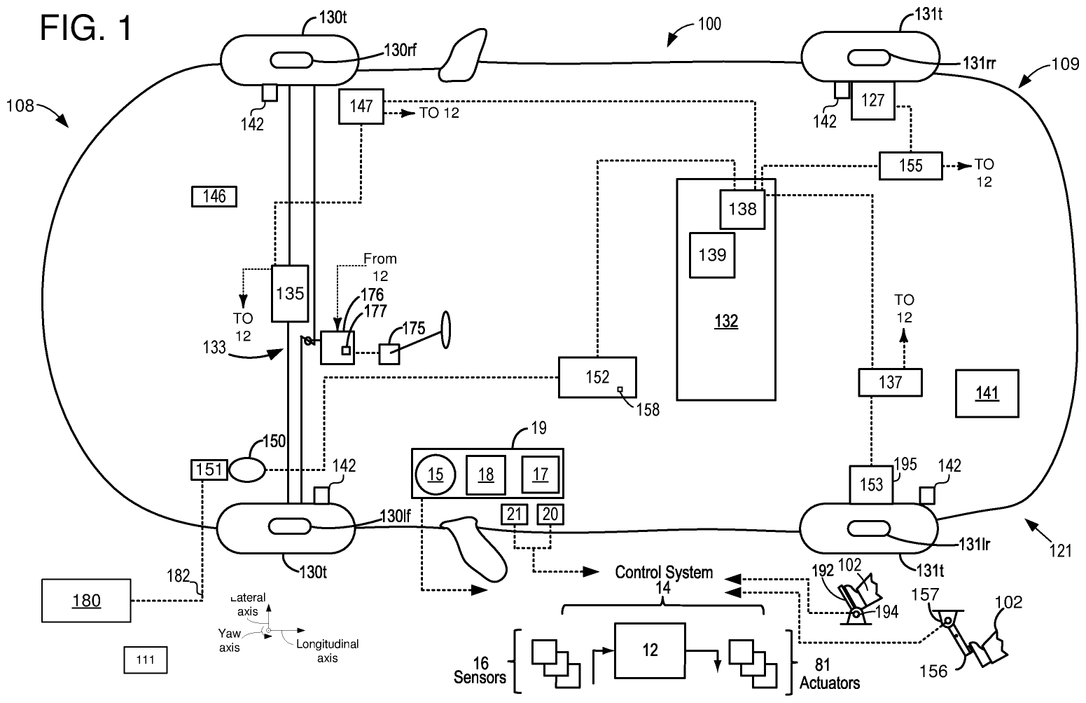

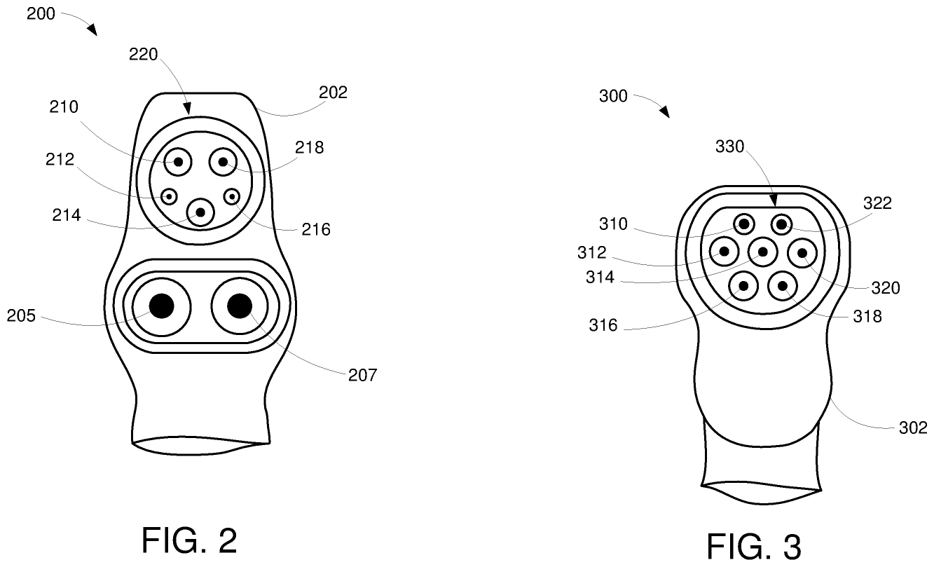

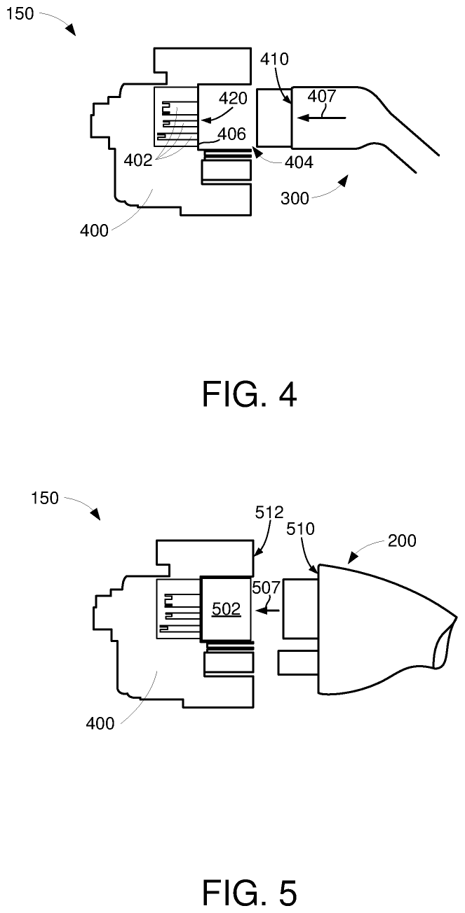

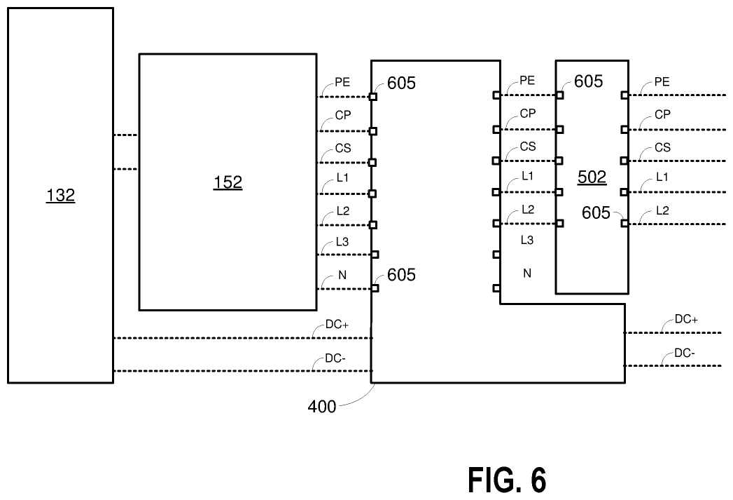

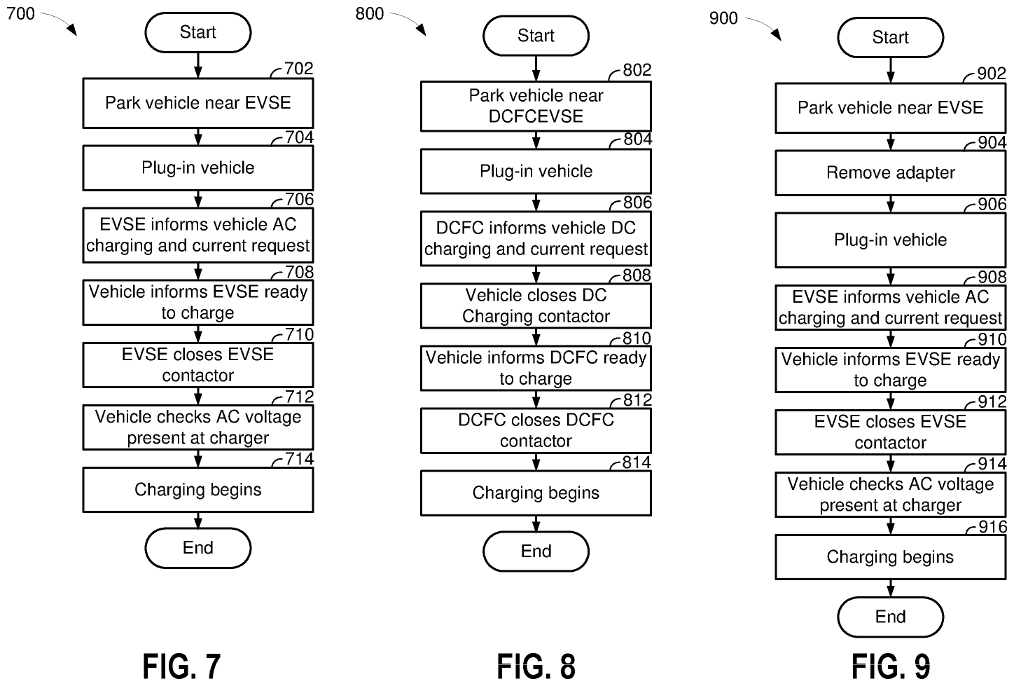

The following description relates to systems and methods for accepting two different charger coupling devices to a single or sole vehicle charging port. The vehicle charging port may be installed in an electric vehicle as shown in FIG. 1 or a hybrid vehicle. Two different charging couplers are shown in FIGS. 2 and 3. A charging port for a vehicle that accepts two different types charging couplers is shown in FIGS. 4 and 5. A wiring block diagram for a charging port is shown in FIG. 6. FIGS. 7-9 show flowcharts of methods for delivering charge to a vehicle via different charge couplers and a single vehicle charging port.

An electric vehicle may include single charging port that may receive charge from one charge coupler. The charge coupler may include electrical connectors for DC charging and AC charging. Further, the charge coupler may include electrical connectors for single phase at a first voltage and single phase at a second voltage. A Society of Automotive Engineers (SAE) J1772/CCS charge coupler may provide electrical connectors for two single phase AC sources and electrical connectors for a DC source. However, a vehicle may be designed to also accept three phase AC charging, and the three phase AC charging may allow the vehicle to accept much faster rates of charging than both of the single phase charging schemes. Therefore, a vehicle owner/operator may seek out three phase chargers. A SAE J3068 charge coupler may provide electrical connectors for single phase and three phase AC. In order to receive charge from J1772/CCS and J3068 charge couplers, a vehicle may be configured with two different charge ports. However, the two charge ports may occupy more vehicle surface area than may be desired and it may be more difficult to wire two charge ports that are positioned close to one another. Therefore, it may be desirable to provide a vehicle charging port that accepts single phase AC, three phase AC, and DC.

The inventors herein have recognized the above-mentioned issues and have developed a charging port for a vehicle, comprising: a housing comprising a plurality of electrically insulated contact supports including contact supports for a first alternating current (AC) phase, contact supports for a second AC phase, contact supports for a third AC phase, contact supports for a neutral line, and contact supports for two DC lines.

By developing a vehicle charging port that accepts single phase AC, three phase AC, and DC power, it may be possible for charging port to have a reduced size and simplify vehicle wiring. Further, the vehicle charging port may allow a vehicle to accept electric power from a larger group of vehicle chargers as compared to vehicles that accept only a single charging coupler.

The present description may provide several advantages. In particular, the approach may simplify vehicle wiring since AC changing may be provided by way of a sole or single charging port. In addition, the approach may reduce a surface area on the vehicle's exterior that is reserved for vehicle charging. Consequently, the vehicle's aesthetic design may benefit from the charging port.

FIG. 1 illustrates an example vehicle propulsion system 100 for vehicle 121. In this example, vehicle propulsion system 100 includes three electric machines that may be applied to propel vehicle 121. Throughout the description of FIG. 1, mechanical connections between various components are illustrated as solid lines, whereas electric connections between various components are illustrated as dashed lines.

In this example, vehicle propulsion system 100 includes an electric machine 153 coupled to solely one a wheel, namely left rear wheel 131lr. Vehicle propulsion system 100 also includes a second electric machine 127 that is coupled solely to one wheel, namely right real wheel 131rr. Vehicle propulsion system 100 drives front axle 133 and front wheels 130lf and 130rf via third electric machine 135. Front axle 133 is positioned toward front 108 of vehicle 121 and electric machines 153 and 127 are positioned toward rear 109 of vehicle 121. Thus, vehicle propulsion system 100 may be propelled by between one and three electric machines.

Electric machine 135, electric machine 127, and electric machine 153 are controlled via controller 12. The controller 12 (e.g., a centralized integrated vehicle control module) receives signals from the various sensors shown in FIG. 1. In addition, controller 12 employs the actuators shown in FIG. 1 to adjust driveline operation based on the received signals and instructions stored in memory of controller 12.

Vehicle propulsion system 100 has a front axle 133 and independently controlled rear wheels 131lr and 131rr. Vehicle propulsion system 100 further includes front wheels 130lf and 13rf. In this example, front wheels 130lf and 130rf and/or rear wheels 131lr and 131rr may be driven via electric propulsion sources. The front axle 133 is coupled to electric machine 135. Electric machine 135 is shown incorporated into front axle 133.

Electric machines 127, 153, and 135 may receive electrical power from onboard electric energy storage device 132. Furthermore, electric machines 127, 153, and 135 may provide a generator function to convert the vehicle's kinetic energy into electric energy, where the electric energy may be stored at electric energy storage device 132 for later use by the electric machine 127, 153, and/or 135. A first inverter system controller (ISC1) 137 may convert alternating current generated by electric machine 153 to direct current for storage at the electric energy storage device 132 and vice versa. First inverter system controller 137 may also convert direct current from electric energy storage device 132 into alternating current to power electric machine 153. A second inverter system controller (ISC2) 155 may convert alternating current generated by electric machine 127 to direct current for storage at the electric energy storage device 132 and vice versa. The second inverter system controller 155 may also convert alternating current generated by electric machine 127 to direct current for storage at the electric energy storage device 132 and vice versa. A third inverter system controller 147 may convert alternating current generated by electric machine 135 to direct current for storage at the electric energy storage device 132 and vice versa. Further, third inverter system controller 147 may convert direct current supplied by electric energy storage device 132 to power electric machine 135.

Electric energy storage device 132 may be a battery, capacitor, inductor, or other electric energy storage device. In some examples, electric energy storage device 132 may be configured to store electric energy that may be supplied to other electric loads residing on-board the vehicle (other than the motor), including cabin heating and air conditioning, vehicle starting, headlights, cabin audio and video systems, etc.

Control system 14 may communicate with one or more of electric machine 135, electric machine 153, electric machine 127, energy storage device 132, etc. Control system 14 may receive sensory feedback information from one or more of electric machine 135, electric machine 127, electric machine 153, energy storage device 132, etc. Further, control system 14 may send control signals to one or more of electric machine 135, electric machine 127, electric machine 153, energy storage device 132, etc., responsive to this sensory feedback. Control system 14 may receive an indication of an operator requested output of the vehicle propulsion system from a human operator 102, or an autonomous controller. For example, control system 14 may receive sensory feedback from driver demand pedal position sensor 194 which communicates with driver demand pedal 192. Similarly, control system 14 may receive an indication of an operator requested vehicle braking via a human operator 102, or an autonomous controller. For example, control system 14 may receive sensory feedback from brake pedal position sensor 157 which communicates with brake pedal 156.

Energy storage device 132 may periodically receive and/or deliver electric energy via external device 180 (e.g., a stationary power grid, power tool, refrigeration unit, etc.) residing external to the vehicle (e.g., not part of the vehicle). As a non-limiting example, vehicle propulsion system 100 may be configured as a plug-in electric vehicle, whereby electric energy may be supplied to energy storage device 132 from external device 180 via an electric energy transmission cable 182 and electric coupler 151. During a charging or discharging operation of energy storage device 132 via external device 180, electric energy transmission cable 182 may electrically couple energy storage device 132 and external device 180. In some examples, external device 180 may be connected at electric vehicle charging port 150.

In some examples, electric energy from external device 180 may be received by charger 152. For example, charger 152 may convert alternating current from external device 180 to direct current (DC), for storage at energy storage device 132. Further, charger 152 may be bi-directional so as to convert DC from electric energy storage device 132 to AC for supply to external device 180. Further, charger 152 may step down or up DC voltage supplied from external device 180 to charge energy storage device 132. Additionally, charger 152 may step up or step down DC voltage from energy storage device 132 supplied to external device 180. Charger 152 may accept single and/or three phase AC power. Charger 152 may be controlled via its own dedicated controller 158 that includes non-transitory memory, a processor, inputs/outputs, and random access memory.

While the vehicle propulsion system is operated to propel the vehicle, electric energy transmission cable 182 may be disconnected between external device 180 and energy storage device 132. Control system 14 may identify and/or control the amount of electric energy stored at the energy storage device 132, which may be referred to as the state of charge (SOC).

Energy storage device 132 may include an electric energy storage device controller 139. Electric energy storage device controller 139 may provide charge balancing between energy storage element (e.g., battery cells) and communication with other vehicle controllers (e.g., controller 12).

One or more wheel speed sensors (WSS) 195 may be coupled to one or more wheels of vehicle propulsion system 100. The wheel speed sensors may detect rotational speed of each wheel. Such an example of a WSS may include a permanent magnet type of sensor.

Vehicle propulsion system 100 may further include an accelerometer 20. Additionally, vehicle propulsion system 100 may further include an inclinometer 21. Vehicle propulsion system 100 may also include a steering control system 176 that may adjust a steering angle via adjusting a position of steering motor 177.

Vehicle propulsion system 100 may further include a brake system control module (BSCM) 141 to apply and release friction wheel brakes 142. In some examples, BSCM 141 may comprise an anti-lock braking system, such that tires (e.g., 130t and 131t) of wheels (e.g. 130lf, 130rf, 131lr, and 131rr) may maintain tractive contact with the road surface according to driver inputs while braking, which may thus prevent the wheels from locking up, to prevent skidding. In some examples, BSCM 141 may receive input from wheel speed sensors 195.

Vehicle propulsion system 100 may further include a motor electronics coolant pump (MECP) 146. MECP 146 may be used to circulate coolant to diffuse heat generated by at least electric machine 127, electric machine 153, and electric machine 135 of vehicle propulsion system 100, and the electronics system. MECP may receive electrical power from onboard energy storage device 132, as an example.

Controller 12 may comprise a portion of a control system 14. In some examples, controller 12 may be a single controller of the vehicle. Control system 14 is shown receiving information from a plurality of sensors 16 (various examples of which are described herein) and sending control signals to a plurality of actuators 81 (various examples of which are described herein). As one example, sensors 16 may include tire pressure sensor(s) 197, wheel speed sensor(s) 195, etc. In some examples, steering angle sensor 175, sensors associated with electric machine 135, electric machine 127, and electric machine 153, etc., may communicate information to controller 12, regarding various states of electric machine operation.

Vehicle propulsion system 100 may also include an on-board navigation system 17 (for example, a Global Positioning System) on dashboard 19 that an operator of the vehicle may interact with. The navigation system 17 may include one or more location sensors for assisting in estimating a location (e.g., geographical coordinates) of the vehicle. For example, on-board navigation system 17 may receive signals from GPS satellites (not shown), and from the signal identify the geographical location of the vehicle. In some examples, the geographical location coordinates may be communicated to controller 12.

Dashboard 19 may further include a display system 18 configured to display information to the vehicle operator. Display system 18 may comprise, as a non-limiting example, a touchscreen, or human machine interface (HMI), display which enables the vehicle operator to view graphical information as well as input commands. In some examples, display system 18 may be connected wirelessly to the internet (not shown) via controller (e.g. 12). As such, in some examples, the vehicle operator may communicate via display system 18 with an internet site or software application (app).

Dashboard 19 may further include an operator interface 15 via which the vehicle operator may adjust the operating status of the vehicle. Specifically, the operator interface 15 may be configured to initiate and/or terminate operation of the vehicle driveline (e.g., electric machine 135, electric machine 127, and electric machine 153) based on an operator input. Various examples of the operator interface 15 may include interfaces that apply a physical apparatus, such as an active key, that may be inserted into the operator interface 15 to activate electric machines 135, 127, and 153, or may be removed to shut down the electric machines 135, 127, and 153 to turn off the vehicle. Still other examples may additionally or optionally use a start/stop button that is manually pressed by the operator to start or shut down the vehicle. In other examples, a remote vehicle start may be initiated remote computing device 111, for example a cellular telephone, or smartphone-based system where a user's cellular telephone sends data to a server and the server communicates with the vehicle controller 12 to start the vehicle.

Referring now to FIG. 2, a front view of a SAE J1772 Combined Charging System (CCS) electric coupler or coupler 200 is shown. Coupler 200 is configured to transfer AC and/or DC power between electric vehicle supply equipment (EVSE) (not shown) or a vehicle charger and a vehicle (not shown).

Coupler 200 includes a DC+contact 207 or terminal (e.g., pin/socket) and a DC-contact 205 or terminal. The DC contacts or terminals may allow the vehicle to be electrically coupled to a DC fast charger DCFC. The DC contacts may transfer DC power from EVSE to a vehicle. DC+ and DC-contacts may protrude from coupler 200.

Coupler 200 also includes a SAE J1772 coupler 220 that is configured to transfer single phase AC electric power from EVSE to a vehicle. Contact 210 is electrically coupled to AC line 1 (L1) electric power and contact 218 is electrically coupled to AC line 2 (L2) electric power. SAE J1772 coupler 220 also includes a control pilot contact 212 and a control status contact 216. Contact 214 is electrically coupled to protective earth ground. Thus, SAE J1772 coupler 220 is configured to transfer single phase 110 volts and single phase 220 volt AC power between EVSE and a vehicle. SAE J1772 coupler 220 may protrude from coupler 200.

Referring now to FIG. 3, a front view of a SAE J3068 electric coupler or coupler 300 is shown. Coupler 300 is configured to transfer AC power between electric vehicle supply equipment (EVSE) (not shown) or a vehicle charger and a vehicle (not shown).

Coupler 300 includes an AC phase 1 contact 312 or terminal (e.g., pin/socket), AC phase 2 contact 316, AC phase 3 contact 318, and AC neutral contact 320 for three phase AC power. Coupler 300 also includes a protective earth contact 314, a control pilot contact 310, and a proximity pilot contact 322. Thus, SAE J3068 coupler 300 is configured to transfer three phase 480 volt AC power between EVSE and a vehicle. SAE J3038 coupler 330 may protrude from coupler 300.

Turning now to FIG. 4, a cut away view of an electric vehicle charging port 150 is shown. Electric vehicle charging port 150 is shown in a cut away view to illustrate how coupler 300 (e.g., SAE J3068) may be inserted into electric vehicle charging port 150 when a vehicle is going to be supplied with charge from an EVSE. Electric vehicle charging port 150 may include a housing 400 that may be formed of an electrically insulating material (e.g., liquid crystal polymer, nylon, polycarbonate, etc.). Housing 400 may include electrically insulated contact supports 402 to support pins/sockets connectors that transfer electric power from a coupler to the electric vehicle charging port 150 and electric systems on board a vehicle. Alternatively, housing 400 may include an electrically insulated connector with SAE J3068 receiving port that is mechanically held in place via housing 400. The electrically insulated contact supports 402 may support contactors for AC and/or DC power. Electric vehicle charging port 150 includes a recess 404 and face 406 of recess 404 may support the electrically insulated contact supports 402 and be mechanically coupled to housing 400. Pins/sockets (not shown) may be inserted into insulated contact supports 402 and the pins/sockets may be electrically coupled to a conductor (not shown) to carry electric power away from electric vehicle charging port 150. Housing 400 includes a SAE J3068 coupler receiving port 420 that includes one or more contacts (e.g., pins/sockets) that are supported by electrically insulated contact supports 402. Electrically insulated contact supports 402 also prevent pins/sockets from moving when a coupler is installed to electric vehicle charging port 150.

In FIG. 4, coupler 300 is shown in a position where it is being prepared to be inserted to electric vehicle charging port 150. Coupler 300 may be installed to electric vehicle charging port 150 by moving coupler 300 in the direction that is indicated by arrow 407. Coupler 300 may be completely installed or electrically coupled to vehicle charging port when shoulder 410 of coupler 300 is in contact with or is proximate to face 406 of recess 404. Thus, coupler 300 may be inserted into electric vehicle charging port 150.

Moving on to FIG. 5, electric vehicle charging port 150 is shown in a cut away view, but in this figure, coupler 200 is shown in a position prior to engaging electric vehicle charging port 150. Electric vehicle charging port 150 is shown in a cut away view to illustrate how coupler 200 (e.g., SAE J1772) may be inserted into electric vehicle charging port 150 when a vehicle is going to be supplied with charge from an EVSE. In order to receive coupler 200, adapter 502 is inserted to fill recess 404 shown in FIG. 4. Adapter 502 may be formed of an electrically insulating material (e.g., liquid crystal polymer, nylon, polycarbonate, etc.) and the electrically insulating material may mechanically support contacts (e.g., pins/sockets) and electrical conductions for electrically coupling contacts (e.g., pins/sockets) of coupling 200 to electric vehicle charging port 150 and other vehicle components. As previously mentioned, housing 400 may include insulated contact supports 402 to support pins/sockets connectors that transfer electric power from a coupler to the electric vehicle charging port 150 and electric systems on board a vehicle.

In FIG. 5, coupler 200 is shown in a position where it is being prepared to be inserted to electric vehicle charging port 150. Coupler 200 may be installed to electric vehicle charging port 150 by moving coupler 200 in the direction that is indicated by arrow 507. Coupler 200 may be completely installed or electrically coupled to vehicle charging port when shoulder 510 of coupler 200 is in contact with or is proximate to face 512 of electric vehicle charging port 150. Coupler 200 inserts its pins/sockets into the pins/sockets of adapter 502 and DC+ and DC-contacts of coupler 200 may be inserted directly into pins/sockets of electric vehicle charging port 150. Thus, coupler 200 may be inserted into electric vehicle charging port 150 and adapter 502 so that electric power may be transferred from EVSE to the vehicle.

Referring now to FIG. 6, a block diagram that shows electrical connections (e.g., dashed lines) between housing 400, adapter 502, and external couplers is presented. Housing 400 may include pins/sockets 605 (depending on configuration) that may mate and contact with pins/sockets 605 of adapter 502 as indicated by the dashed lines. Each of the dashed lined is associated with pins/sockets that may carry a specific electric signal. For example, the conductor labeled L1 may carry single phase AC electric power. Similarly, the conductor labeled L2 may carry single phase AC electric power for 220 volt charging. Thus, adapter 502 does not carry conductors for carrying or transferring DC electric power. Yet, DC electric power may be transferred directly from the pins/sockets 605 that are held within housing 400 to a coupler.

Housing 400 includes pins/sockets that are coupled to charger 152 (e.g., an AC/DC converter) via conductors (e.g., dashed lines). AC lines L1-L3, N, and PE are coupled to charger 152 along with CP and CS lines. The DC+ and DC-lines may bypass charger 152 and be directly coupled to electric energy storage device 132, or in some examples, a DC/DC converter may be placed between housing 400 and electric energy storage device 132.

Thus, the system of FIGS. 1-6 provides for a charging port for a vehicle, comprising: a housing comprising a plurality of electrically insulated contact supports including contact supports for a first alternating current (AC) phase, contact supports for a second AC phase, contact supports for a third AC phase, contact supports for a neutral line, and contact supports for two DC lines. In a first example, the charging port further comprises a recess in the housing, the recess configured to receive a SAE J1772 coupler during a first condition, the recess configured to receive an adapter during a second condition. In a second example that may include the first example, the charging port includes where the first condition is receiving electrical charge from a first electric vehicle supply equipment (EVSE). In a third example that may include one or both of the first and second examples, the charging port includes where the second condition is receiving electrical charge from a second EVSE, where the second EVSE is configured to supply a different electric power to the vehicle than the first EVSE. In a fourth example that may include one or more of the first through third examples, the charging port includes where the first EVSE supplies single phase electric power to the vehicle. In a fifth example that may include one or more of the first through fourth examples, the charging port includes where the second EVSE supplies three phase electric power to the vehicle. In a sixth example that may include one or more of the first through fifth examples, the charging port includes where the charging port is electrically coupled to an AC to DC converter. In a seventh example that may include one or more of the first through sixth examples, the charging port includes where the AC to DC converter converts three phase AC power to DC power.

The system of FIGS. 1-6 also provides for a charging port for a vehicle, comprising: a housing configured to receive a Society of Automotive Engineers (SAE) J3068 coupler without an adapter and the adapter without the SAE J3068 coupler via a single J3068 receiving port, the housing also configured to accept a Combined Charging System (CCS) DC coupler. In a first example, the charging port includes where the adapter is configured to receive a SAE J1772 coupler. In a second example that may include the first example, the charging port further comprises a recess within the housing, the recess configured to receive the SAE J3068 coupler. In a third example that may include one or more of the first and second examples, the charging port further comprises a plurality of contacts configured to transfer electric power from electric vehicle supply equipment to a battery aboard the vehicle. In a fourth example that may include one or more of the first through third examples, the charging port includes where the adapter is configured to transfer electric power between the single SAE J3068 receiving port and a SAE J1772 coupler.

Referring now to FIG. 7, a flow chart of an example method for charging a vehicle via a single or sole vehicle charging port is shown. The method of FIG. 7 pertains to charging an electric vehicle via AC charging and a SAE J1772 Combined Charging System (CCS) coupler when a charging adapter (e.g., 502) is installed to an electric vehicle charging port 150. The method of FIG. 7 may be incorporated into and may cooperate with the systems of FIGS. 1-6. Further, at least portions of the method of FIG. 7 may be incorporated as executable instructions stored in non-transitory memory of one or more controllers. Additionally, portions of the method of FIG. 7 may be performed via a human.

At 702 of method 700, an electric vehicle is parked proximate to EVSE in preparation for charging the vehicle. The electric vehicle is parked proximate to EVSE so that electric cables and couplers may reach the vehicle from the EVSE. The electric vehicle may be parked via a human or an autonomous driver. Method 700 proceeds to 704.

At 704 of method 700, the electric vehicle is plugged into the EVSE. The vehicle may be plugged in to the EVSE via a human or a machine. Method 700 proceeds to 706.

At 706 of method 700, the EVSE informs the vehicle that AC charging and current are available. The EVSE may send serial data to the vehicle to notify the vehicle of vehicle charging options according to the EVSE specifications. Method 700 proceeds to 708.

At 708 of method 700, the vehicle informs the EVSE it is ready to receive the offered AC power. Method 700 proceeds to 710.

At 710 of method 700, the EVSE closes an EVSE contactor so that AC power is supplied to the SAE J1772 Combined Charging System (CCS) coupler and the vehicle. In this example, 220 VAC is delivered to the vehicle. Method 700 proceeds to 712.

At 712 of method 700, the vehicle checks to determine if the AC voltage that is received via the charger coupler to the vehicle is within a specified range. If so, method 700 begins to store charge in an electric storage device at 714. Method 700 proceeds to exit.

In this way, single phase AC power may be supplied to an electric vehicle via a single or sole charging port that may receive different types of AC power via a single charging port and a plurality of different electric couplers.

Referring now to FIG. 8, a flow chart of an example method for charging a vehicle via a single or sole vehicle charging port is shown. The method of FIG. 8 pertains to charging an electric vehicle via DC charging and a SAE J1772 Combined Charging System (CCS) coupler when a charging adapter (e.g., 502) is installed to an electric vehicle charging port 150. The method of FIG. 8 may be incorporated into and may cooperate with the systems of FIGS. 1-6. Further, at least portions of the method of FIG. 8 may be incorporated as executable instructions stored in non-transitory memory of one or more controllers. Additionally, portions of the method of FIG. 8 may be performed via a human.

At 802 of method 800, an electric vehicle is parked proximate to EVSE in preparation for charging the vehicle. The electric vehicle is parked proximate to EVSE so that electric cables and couplers may reach the vehicle from the EVSE. The electric vehicle may be parked via a human or an autonomous driver. Method 800 proceeds to 804.

At 804 of method 800, the electric vehicle is plugged into the EVSE. The vehicle may be plugged in to the EVSE via a human or a machine. Method 800 proceeds to 806.

At 806 of method 800, the DCFC informs the vehicle that DC charging and current are available. The DCFC may send serial data to the vehicle to notify the vehicle of vehicle charging options according to the DCFC specifications. Method 800 proceeds to 808.

At 808 of method 800, the vehicle closes the DC contactor so that DC power may flow to the vehicle. The DC contactor may be included in the vehicle and it may electrically isolate the electric vehicle charging port 150 from the electric energy storage device 132. Method 800 proceeds to 810.

At 810 of method 800, the vehicle informs the DCFC that the vehicle is ready to receive DC charge. Method 800 proceeds to 812.

At 812 of method 800, the DCFC closes its own DC contactor so that DC charge may flow to the vehicle. Method 800 proceeds to 814 where DC charging of the electric energy storage device begins.

In this way, three phase DC power may be supplied to an electric vehicle via a single or sole charging port that may receive different types of AC power and DC power via a single charging port and a plurality of different electric couplers.

Referring now to FIG. 9, a flow chart of an example method for charging a vehicle via a single or sole vehicle charging port is shown. The method of FIG. 9 pertains to charging an electric vehicle via AC charging and a SAE J3068 coupler when a charging adapter (e.g., 502) is not installed to an electric vehicle charging port 150. The method of FIG. 9 may be incorporated into and may cooperate with the systems of FIGS. 1-6. Further, at least portions of the method of FIG. 9 may be incorporated as executable instructions stored in non-transitory memory of one or more controllers. Additionally, portions of the method of FIG. 9 may be performed via a human.

At 902 of method 900, an electric vehicle is parked proximate to EVSE in preparation for charging the vehicle. The electric vehicle is parked proximate to EVSE so that electric cables and couplers may reach the vehicle from the EVSE. The electric vehicle may be parked via a human or an autonomous driver. Method 900 proceeds to 904.

At 904 of method 900, the adapter (e.g., 502) is removed from the electric vehicle charging port 150 and its housing 400. The adapter may be removed via a human or a machine. Method 900 proceeds to 906.

At 906 of method 900, the electric vehicle is plugged into the EVSE. The vehicle may be plugged in to the EVSE via a human or a machine. Method 900 proceeds to 908.

At 908 of method 900, the EVSE informs the vehicle that AC charging and current are available. The EVSE may send serial data to the vehicle to notify the vehicle of vehicle charging options according to the EVSE specifications. Method 900 proceeds to 908.

At 910 of method 900, the vehicle informs the EVSE it is ready to receive the offered AC power. Method 900 proceeds to 912.

At 912 of method 900, the EVSE closes an EVSE contactor so that AC power is supplied to the SAE J3068 coupler and the vehicle. In this example, three phase AC is delivered to the vehicle. The three phase AC power may be supplied at 480 volts. Method 900 proceeds to 914. At 914 of method 900, the vehicle checks to determine if the AC voltage that is received via the charger coupler to the vehicle is within a specified range. If so, method 900 begins to store charge in an electric storage device at 916. Method 900 proceeds to exit.

In this way, three phase AC power may be supplied to an electric vehicle via a single or sole charging port that may receive different types of AC power via a single charging port and a plurality of different electric couplers.

Thus, the methods of FIGS. 7-8 provide for a method for supplying electric power from a vehicle, comprising: inserting a first electric coupler into a recess of a vehicle charging port during a first condition; inserting an adapter into the recess of the vehicle charging port during a second condition; and inserting a second electric coupler into the adapter, the second electric coupler different than the first electric coupler. In a first example, the method includes where the adapter is inserted into a port in the vehicle charging port and the port is configured to receive a SAE J3068 coupler. In a second example that may include the first example, the method includes where the adapter is configured to receive a SAE J1772 coupler. In a third example that may include one or both of the first and second examples, the method further comprises supplying electric power to the vehicle via the first electric coupler. In a fourth example that may include one or more of the first through third examples, the method includes where the electric power is three phase electric power. In a fifth example that may include one or more of the first through fourth examples, the method further comprises supplying electric power to the vehicle via the second electric coupler. In a sixth example that may include one or more of the first through fifth examples, the method includes where the electric power is single phase electric power.

Note that the example control and estimation routines included herein can be used with various vehicle and powertrain configurations. The control methods and routines disclosed herein may be stored as executable instructions in non-transitory memory and may be carried out by the control system including the controller in combination with the various sensors, actuators, and other vehicle hardware.

Further, portions of the methods may be physical actions taken in the real world to change a state of a device. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example examples described herein, but is provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the vehicle control system, where the described actions are carried out by executing the instructions in a system including the various vehicle hardware components in combination with the electronic controller. One or more of the method steps described herein may be omitted if desired.

It will be appreciated that the configurations and routines disclosed herein are exemplary in nature, and that these specific examples are not to be considered in a limiting sense, because numerous variations are possible. For example, the above technology can be applied to induction electric machines and permanent magnet electric machines. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims may be understood to include incorporation of one or more such elements, neither requiring nor excluding two or more such elements. Other combinations and sub-combinations of the disclosed features, functions, elements, and/or properties may be claimed through amendment of the present claims or through presentation of 10 new claims in this or a related application. Such claims, whether broader, narrower, equal, or different in scope to the original claims, also are regarded as included within the subject matter of the present disclosure.

1. A charging port for a vehicle, comprising:
a housing comprising a plurality of electrically insulated contact supports including contact supports for a first alternating current (AC) phase, contact supports for a second AC phase, contact supports for a third AC phase, contact supports for a neutral line, and contact supports for two DC lines.

2. The charging port for the vehicle of claim 1, further comprising a recess in the housing, the recess configured to receive a SAE J1772 coupler during a first condition, the recess configured to receive an adapter during a second condition.

3. The charging port for the vehicle of claim 2, where the first condition is receiving electrical charge from a first electric vehicle supply equipment (EVSE).

4. The charging port for the vehicle of claim 3, where the second condition is receiving electrical charge from a second EVSE, where the second EVSE is configured to supply a different electric power to the vehicle than the first EVSE.

5. The charging port for the vehicle of claim 4, where the first EVSE supplies single phase electric power to the vehicle.

6. The charging port for the vehicle of claim 5, where the second EVSE supplies three phase electric power to the vehicle.

7. The charging port for the vehicle of claim 1, where the charging port is electrically coupled to an AC to DC converter.

8. The charging port for the vehicle of claim 7, where the AC to DC converter converts three phase AC power to DC power.

9. A method for supplying electric power from a vehicle, comprising:
inserting a first electric coupler into a recess of a vehicle charging port during a first condition;
inserting an adapter into the recess of the vehicle charging port during a second condition; and
inserting a second electric coupler into the adapter, the second electric coupler different than the first electric coupler.

10. The method of claim 9, where the adapter is inserted into a port in the vehicle charging port and the port is configured to receive a SAE J3068 coupler.

11. The method of claim 10, where the adapter is configured to receive a SAE J1772 coupler.

12. The method of claim 9, further comprising supplying electric power to the vehicle via the first electric coupler.

13. The method of claim 12, where the electric power is three phase electric power.

14. The method of claim 9, further comprising supplying electric power to the vehicle via the second electric coupler.

15. The method of claim 14, where the electric power is single phase electric power.

16. A charging port for a vehicle, comprising:
a housing configured to receive a Society of Automotive Engineers (SAE) J3068 coupler without an adapter and the adapter without the SAE J3068 coupler via a single SAE J3068 coupler receiving port, the housing also configured to accept a Combined Charging System (CCS) DC coupler.

17. The charging port for the vehicle of claim 16, where the adapter is configured to receive a SAE J1772 coupler.

18. The charging port for the vehicle of claim 17, further comprising a recess within the housing, the recess configured to receive the SAE J3068 coupler.

19. The charging port for the vehicle of claim 16, further comprising a plurality of contacts configured to transfer electric power from electric vehicle supply equipment to a battery aboard the vehicle.

20. The charging port for the vehicle of claim 16, where the adapter is configured to transfer electric power between the SAE J3068 coupler receiving port and a SAE J1772 coupler.
